(19) United States
(12) Patent Application Publication
(10) Pub. No.: US 2025/0081189 A1
(43) Pub. Date: Mar. 6, 2025

(54) METHOD AND DEVICE FOR CONFIGURING UPLINK GAP, AND STORAGE MEDIUM

(71) Applicant: BEIJING XIAOMI MOBILE SOFTWARE CO., LTD., Beijing (CN)

(72) Inventor: Xuhua TAO, Beijing (CN)

(73) Assignee: BEIJING XIAOMI MOBILE SOFTWARE CO., LTD., Beijing (CN)

(21) Appl. No.: 18/726,570

(22) PCT Filed: Jan. 4, 2022
(86) PCT No.: PCT/CN2022/070172

§ 371 Date: Jul. 3, 2024

(51) Int. Cl. H04W 72/1268; H04L 5/00

(52) U.S. Cl. CPC H04W 72/1268; H04L 5/0005

(57) ABSTRACT

Provided in the present disclosure are a method and device for configuring an uplink gap, and a readable storage medium, which are applied to the technical field of wireless communications. The method is performed by a user device and includes: receiving uplink gap (ULgap) configuration information from a network device, where the ULgap configuration information indicates a gap in which the user device is prohibited from scheduling uplink information when an uplink signal is interfered with by an In Device Coexistence (IDC) signal.

### CROSS-REFERENCE TO RELATED APPLICATIONS

The present disclosure is the U.S. National Stage of International Application No. PCT/CN2022/070172, filed on Jan. 4, 2022, the entire content of which is incorporated herein by reference for all purposes.

### TECHNICAL FILED

The present disclosure relates to the field of wireless communication technology, and in particular to a method and device for configuring an uplink gap, and a readable storage medium.

### BACKGROUND

Currently, mobile terminals generally have three or more wireless devices coexisting. Due to the lack of unified management of frequency band usage for different systems, interference issues between uplink and downlink of different wireless systems may occur when they work simultaneously, such as between Long Term Evolution (LTE) and Wireless Local Area Network (WLAN), between LTE and Bluetooth®, between LTE and Global Navigation Satellite System (GNSS), LTE and Universal Serial Bus (USB), etc. This interference can be referred to as In Device Coexistence (IDC) interference, which may cause one or more of the wireless devices to fail to operate properly or fail to operate efficiently.

IDC signals may interfere with the uplink transmission of New Radio (NR), and thus, it is necessary to address the issue in uplink transmission caused by the IDC interference.

### SUMMARY

In view of the above, this disclosure provides a method and device for configuring an uplink gap, and a readable storage medium.

In a first aspect, a method for configuring an uplink gap is provided, which is performed by a user device and includes:
receiving uplink gap (ULgap) configuration information from a network device, where the ULgap configuration information is configured for indicating a gap in which the user device is prohibited from scheduling uplink information when an uplink signal is interfered with by an IDC signal.

In a second aspect, a method for configuring an uplink gap is provided, which is performed by a network device and includes:
sending uplink gap (ULgap) configuration information to a user device, where the ULgap configuration information is configured for indicating a gap in which the user device is prohibited from scheduling uplink information when an uplink signal is interfered with by an IDC signal.

In a third aspect, a communication device is provided, including a processor and a memory, where the memory is configured to store a computer program; and the processor is configured to execute the computer program to perform any one of the possible methods as in the first aspect or in the first aspect.

In a fourth aspect, a communication device is provided, including a processor and a memory, where the memory is configured to store a computer program; and the processor is configured to execute the computer program to perform any one of the possible methods as in the second aspect or in the second aspect.

In a fifth aspect, a non-transitory computer-readable storage medium is provided. The computer-readable storage medium stores instructions (or computer program, or program), which when executed on a computer, cause the computer to perform any possible design in the first aspect or according to the first aspect.

In a sixth aspect, a non-transitory computer-readable storage medium is provided. The computer-readable storage medium stores instructions (or computer program, or program), which when executed on a computer, cause the computer to perform any possible design in the second aspect or according to the second aspect.

It should be understood that the general description above and the detailed description below are exemplary and explanatory, and should not be construed as limiting the disclosure.

### BRIEF DESCRIPTION OF THE DRAWINGS

The accompanying drawings illustrated herein are used to provide a further understanding of the embodiments of the present disclosure and form a part of this application. Embodiments of this disclosure and explanations thereof are provided to explain the embodiments disclosed and do not constitute undue limitation on the embodiments disclosed.

The drawings herein, which are incorporated into and form a part of the specification, illustrate examples consistent with the embodiments of this disclosure and are used in conjunction with the specification to explain the principles of the embodiments of this disclosure.

FIG. 1 is a schematic diagram of the architecture of a wireless communication system provided according to the embodiments of this disclosure.

FIG. 2 is a flowchart of a method for configuring an uplink gap illustrated according to an embodiment.

FIG. 3 is a flowchart of a method for configuring an uplink gap illustrated according to an embodiment.

FIG. 4 is a flowchart of a method for configuring an uplink gap illustrated according to an embodiment.

FIG. 5 is a schematic diagram of a kind of configured uplink gaps illustrated according to an embodiment.

FIG. 6 is a flowchart of a method for configuring an uplink gap illustrated according to an embodiment.

FIG. 7 is a flowchart of a method for configuring an uplink gap illustrated according to an embodiment.

FIG. 8 is a flowchart of a method for configuring an uplink gap illustrated according to an embodiment.

FIG. 9 is a flowchart of a method for configuring an uplink gap illustrated according to an embodiment.

FIG. 10 is a flowchart of a method for configuring an uplink gap illustrated according to an embodiment.

FIG. 11 is a flowchart of a method for configuring an uplink gap illustrated according to an embodiment.

FIG. 12 is a structural diagram of a device for configuring an uplink gap illustrated according to an embodiment.

FIG. 13 is a structural diagram of a device for configuring an uplink gap illustrated according to an embodiment.

FIG. 14 is a structural diagram of a device for configuring an uplink gap illustrated according to an embodiment.

FIG. 15 is a structural diagram of a device for configuring an uplink gap illustrated according to an embodiment.

### DETAILED DESCRIPTION

The embodiments of this disclosure will now be further explained in conjunction with the drawings and specific implementations.

Embodiments are described in detail herein, examples of which are represented in the accompanying drawings. When the following description relates to the accompanying drawings, unless otherwise indicated, the same numbers in different drawings represent the same or similar elements. The implementations described in the embodiments below do not represent all embodiments consistent with the disclosure. Instead, they are examples of devices and methods consistent with some aspects of the disclosure as detailed in the appended claims.

The terms used in this disclosure are for the purpose of describing specific embodiments and are not intended to limit this disclosure. The singular forms “a,” “an,” and “the” used in the disclosure and the appended claims are intended to include the plural forms unless the context clearly indicates otherwise. Additionally, the term “and/or” used herein refers to any or all possible combinations of one or more of the associated listed items.

It should be understood that although terms like “first,” “second,” “third,” etc., may be used to describe various information in the embodiments of this disclosure, the information is not limited by these terms. These terms are used only to distinguish the same type of information from each other. For example, without departing from the scope of embodiments of this disclosure, the first information may also be referred to as the second information, and similarly, the second information may also be referred to as the first information. Depending on the context, the terms “if” and “in case . . . ”, as used herein, can be interpreted as “at the time of . . . ”, “when . . . ” or “in response to determining”.

Embodiments of this disclosure are described in detail below, examples of which are shown in the accompanying drawings, where the same or similar symbols throughout indicate the same or similar elements. The embodiments described below with reference to the accompanying drawings are exemplary and are intended to be used to explain this disclosure and are not to be construed as limitations of this disclosure.

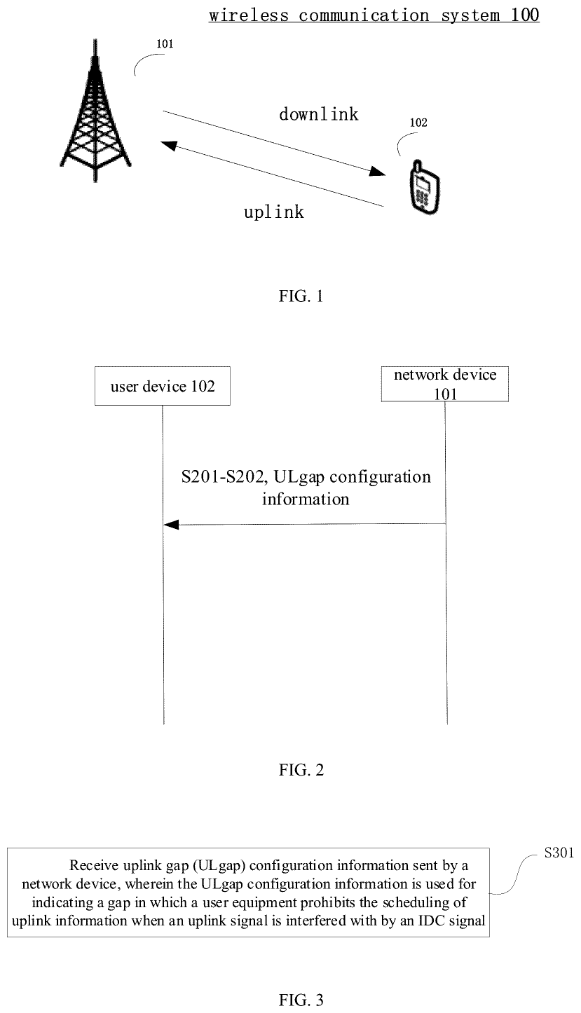

As shown in FIG. 1, a method for configuring an uplink gap provided in the embodiments of this disclosure can be applied to a wireless communication system 100. The wireless communication system may include, but is not limited to, a network device 101 and a user device 102. The user device 102 is configured to support carrier aggregation and can connect to multiple carrier units of the network device 101, including a primary carrier unit and one or more secondary carrier units.

It should be understood that the wireless communication system 100 can be applicable to both low-frequency and high-frequency scenarios. Application scenarios of the wireless communication system 100 include, but are not limited to, Long Term Evolution (LTE) systems, LTE Frequency Division Duplex (FDD) systems, LTE Time Division Duplex (TDD) systems, Worldwide Interoperability for Microwave Access (WiMAX) communication systems, Cloud Radio Access Network (CRAN) systems, future 5^{th}-Generation (5G) systems, New Radio (NR) communication systems, or future evolved Public Land Mobile Network (PLMN) systems, etc.

The user device 102 described above can be User Equipment (UE), a terminal, an access terminal, a terminal unit, a terminal station, a mobile station (MS), a remote station, a remote terminal, a mobile terminal, a wireless communication device, a terminal agent, or a user device, among others. The user device 102 may have wireless receiving and sending capabilities, allowing it to communicate (such as wirelessly) with one or more network devices 101 of one or more communication systems and to receive network services provided by the network device 101. Here, the network device 101 includes, but is not limited to, the base station as shown.

The user device 102 can be a cellular phone, a cordless phone, a Session Initiation Protocol (SIP) phone, a Wireless Local Loop (WLL) station, a Personal Digital Assistant (PDA), a handheld device with wireless communication capabilities, a computing device, other processing device connected to a wireless modem, a vehicle-mounted device, a wearable device, a user device in future 5G networks, or a user device in future evolved PLMN networks, etc.

The network device 101 can be an access network device (or access network station). An access network device refers to a device that provides network access functions, such as a Radio Access Network (RAN) base station, and so on. The network device may specifically include base station (BS) equipment, or BS equipment along with wireless resource management equipment for controlling the BS equipment. The network device may also include a relay station (relay device), access point, base station in future 5G networks, base station in future evolved PLMN networks, or NR base station. The network device may be a wearable device or vehicle-mounted device. The network device may also be a communication chip with a communication module.

For example, the network device 101 includes but is not limited to: a next-generation base station (gNodeB or gNB) in the 5G system, an evolved node B (eNB) in the LTE system, a Radio Network Controller (RNC), a Node B (NB) in the Wideband Code Division Multiple Access (WCDMA) system, a wireless controller in the Cloud-Radio Access Network (CRAN) system, a Base Station Controller (BSC), a Base Transceiver Station (BTS) in a Global System for Mobile Communications (GSM) or Code Division Multiple Access (CDMA) system, a Home base station (e.g., Home evolved NodeB, or Home Node B, or HNB), a Baseband Unit (BBU), a Transmitting and Receiving Point (TRP), a Transmitting Point (TP), or a Mobile Switching Center, etc.

According to the embodiments of this disclosure, a method for configuring an uplink gap is provided. FIG. 2 is a flowchart of a method for configuring an uplink gap illustrated according to an embodiment. As shown in FIG. 2, the method includes the following steps.

Step S201, sending, by a network device 101, uplink gap (ULgap) configuration information to a user device 102, where the ULgap configuration information is configured for indicating a gap in which the user device is prohibited from scheduling uplink information when an uplink signal is interfered with by an IDC signal.

Step S202, receiving, by the user device 102, the ULgap configuration information from the network device 101, where the ULgap configuration information is configured for indicating the gap in which the user device is prohibited from scheduling the uplink information when the uplink signal is interfered by the IDC signal.

In some possible embodiments, the IDC signal may be at least one kind of the following signals: a WLAN signal, a Bluetooth signal, a GNSS signal, or an USB signal.

In the embodiments of this disclosure, the network device configures ULgap configuration information for the user device, where the ULgap configuration information corresponds to one or more ULgaps which correspond to a period during which an uplink signal is interfered with by an IDC signal, so as to prohibit scheduling of uplink information by the user device within the corresponding gap(s). This prevents the user device from sending interfered-uplink information to the network device and affecting the effectiveness of the uplink information, thereby improving the communication quality, and optimizing the network performance.

According to the embodiments of this disclosure, a method for configuring an uplink gap is provided, which is performed by a user device. FIG. 3 is a flowchart of a method for configuring an uplink gap illustrated according to an embodiment. As shown in FIG. 3, the method includes the following steps.

Step S301, receiving ULgap configuration information from a network device, where the ULgap configuration information is configured for indicating a gap in which the user device is prohibited from scheduling uplink information when an uplink signal is interfered with by an IDC signal.

In some possible embodiments, the IDC signal may be at least one kind of the following signals: a WLAN signal, a Bluetooth signal, a GNSS signal, or an USB signal.

In some possible embodiments, after the user device receives the ULgap configuration information sent by the network device, it does not schedule uplink information within the gap(s) indicated by the ULgap configuration information.

In the embodiments of this disclosure, the user device receives the ULgap configuration information configured by the network device for the user device, where the ULgap configuration information corresponds to one or more ULgaps which correspond to a period during which an uplink signal is interfered with by an IDC signal, so as to prohibit scheduling of uplink information by the user device within the corresponding gap(s). This prevents the user device from sending interfered-uplink information to the network device and affecting the effectiveness of the uplink information, thereby improving the communication quality, and optimizing the network performance.

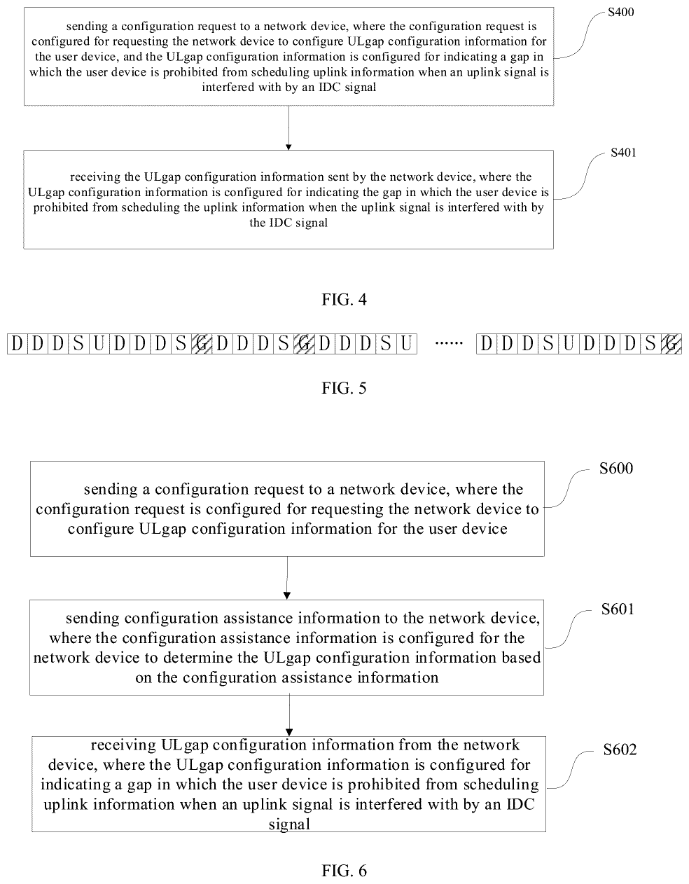

According to the embodiments of this disclosure, a method for configuring an uplink gap is provided, which is performed by a user device. FIG. 4 is a flowchart of a method for configuring an uplink gap illustrated according to an embodiment. As shown in FIG. 4, the method includes the following steps.

Step S400, sending a configuration request to a network device, where the configuration request is configured for requesting the network device to configure ULgap configuration information for the user device, and the ULgap configuration information is configured for indicating a gap in which the user device is prohibited from scheduling uplink information when an uplink signal is interfered with by an IDC signal.

Step S401, receiving the ULgap configuration information sent by the network device, where the ULgap configuration information is configured for indicating the gap in which the user device is prohibited from scheduling the uplink information when the uplink signal is interfered with by the IDC signal.

In some possible embodiments, the IDC signal may be at least one kind of the following signals: a WLAN signal, a Bluetooth signal, a GNSS signal, or an USB signal.

In some possible embodiments, the ULgap configuration information is default ULgap configuration information.

In some possible embodiments, the ULgap configuration information is preset ULgap configuration information.

In some possible embodiments, the ULgap configuration information is configured for configuring periodic ULgaps, where the ULgap configuration information corresponds to the periodic ULgaps. The ULgap configuration information includes at least one kind of the following:
a repetition period of the uplink gaps (i.e., ULGapRepetitionPeriod), where a length of the period of the uplink gaps is a length of time or a multiple based on a unit time domain length;
a length of the uplink gaps (UL GapLength); or
a starting offset value of the uplink gaps (ULgapoffset).

In some possible examples, the unit time domain length may be a configurable time domain length, such as a single-slot length, a half-slot length, a two-slot length, or a length greater than two slots.

As shown in FIG. 5, the length of the uplink gaps is the length of all time domain blocks labeled as “G” in FIG. 5. The time domain blocks labeled as “G” correspond to uplink time domain blocks, not downlink time domain blocks or special time domain blocks. For example, the length of a time domain block is one slot, and the time domain blocks labeled as “G” in FIG. 5 correspond to uplink slots, not downlink slots or special slots.

In some possible embodiments, the ULgap configuration information is configured for configuring one or more non-periodic ULgaps, where the ULgap configuration information corresponds to the one or more non-periodic ULgaps.

The ULgap configuration information includes a second time domain length, where the second time domain length corresponds to a length (or a length of time, or duration) of the uplink gap.

In some possible examples, the ULgap configuration information includes a non-periodic ULgap, where the second time domain length is the length of this ULgap.

In some possible examples, the ULgap configuration information includes more than one non-periodic ULgap, where the second time domain length is the length of all of the more than one non-periodic ULgap.

In some possible examples, the ULgap configuration information includes more than one non-periodic ULgap and the second time domain length, where the ULgap configuration information includes the position and length of each non-periodic ULgap, and the second time domain length is the length of all of the more than one non-periodic ULgap.

In some possible examples, the ULgap configuration information includes more than one non-periodic ULgap and the second time domain length, where the ULgap configuration information does not include the position and length of each non-periodic ULgap. The UE can determine the position and length of the non-periodic ULgap based on the configuration information of uplink slots and downlink slots. For example, the non-periodic ULgaps are all of the uplink slots within the time period corresponding to the second time domain length.

In some possible embodiments, the ULgap configuration information is configured for configuring the periodic ULgaps or non-periodic ULgap, and the ULgap configuration information also includes an ULgap type, where the ULgap type is a per-band type or a band combination-based type.

In the embodiments of this disclosure, the user device actively sends a configuration request to the network device to trigger the network device to send ULgap configuration information, allowing the network device to send ULgap configuration information only when needed by the user device, thus saving transmission resources.

According to the embodiments of this disclosure, a method for configuring an uplink gap is provided, which is performed by a user device. FIG. 6 is a flowchart of a method for configuring an uplink gap illustrated according to an embodiment. As shown in FIG. 6, the method includes the following steps.

Step S600, sending a configuration request to a network device, where the configuration request is configured for requesting the network device to configure ULgap configuration information for the user device.

Step S601, sending configuration assistance information to the network device, where the configuration assistance information is configured for the network device to determine the ULgap configuration information based on the configuration assistance information.

Step S602, receiving ULgap configuration information from the network device, where the ULgap configuration information is configured for indicating a gap in which the user device is prohibited from scheduling uplink information when an uplink signal is interfered with by an IDC signal.

Alternatively, the method may not include step S600 and only include steps S601 and S602.

In some possible embodiments, the IDC signal may be at least one kind of the following signals: a WLAN signal, a Bluetooth signal, a GNSS signal, or an USB signal.

In some possible embodiments, the first signaling used for sending the configuration request to the network device is the same signaling or different signaling from the second signaling used for sending the configuration assistance information to the network device.

In some possible embodiments, the configuration assistance information includes at least one kind of the following information:
first assistance information configured for indicating a first time domain length during which the uplink signal is interfered;
second assistance information configured for indicating a period of the interference on the uplink signal;
third assistance information configured for indicating a frequency band that is interfered; or
fourth assistance information configured for indicating at least two frequency bands that are interfered.

In some possible embodiments, the first time domain length is a total number of time slots (or called number of ULslots) or a total length of time when the uplink signal is interfered by the IDC signal.

In the embodiments of this disclosure, the user device actively sends configuration assistance information to the network device, allowing the network device to determine ULgap configuration information based on the configuration assistance information. In this way, the network device determines the ULgap configuration information based on the configuration assistance information reported by the user device, which enables the network device to configure the ULgap configuration information required by the user device based on the needs of the user device, thereby optimizing the network performance.

According to the embodiments of this disclosure, a method for configuring an uplink gap is provided, which is performed by a user device. The method includes:
sending configuration assistance information to a network device, where the configuration assistance information is configured for the network device to determine the ULgap configuration information based on the configuration assistance information; and
receiving the ULgap configuration information from the network device, where the ULgap configuration information is configured for indicating a gap in which the user device is prohibited from scheduling uplink information when an uplink signal is interfered with by an IDC signal, and the ULgap configuration information includes at least one kind of the following:
a repetition period of the uplink gaps, where a length of the period of the uplink gaps is a length of time or a multiple based on a unit time domain length;
a length of the uplink gaps; or
a starting offset value of the uplink gaps.

In some possible examples, the unit time domain length may be a configurable time domain length, such as a single-slot length, a half-slot length, a two-slot length, or a length greater than two slots.

In some possible embodiments, the configuration assistance information includes at least one kind of the following information:
first assistance information configured for indicating a first time domain length during which the uplink signal is interfered;
second assistance information configured for indicating a period of the interference on the uplink signal;
third assistance information configured for indicating a frequency band that is interfered; or
fourth assistance information configured for indicating at least two frequency bands that are interfered.

In the embodiments of this disclosure, when the network device receives configuration assistance information from the user device, it configures periodic ULgaps for the user device.

In some possible embodiments, the configuration assistance information includes the second assistance information configured for indicating the period of the interference on the uplink signal. In this embodiments, when the user device reports the period of the interference on the uplink signal, corresponding periodic ULgaps are allocated for the user device to meet the user device's needs.

In some possible embodiments, the configuration assistance information includes the second assistance information configured for indicating the period of the interference on the uplink signal, and the third assistance information configured for indicating a frequency band that is interfered. In this embodiment, when the user device reports the period of the interference on the uplink signal which is applicable to the same frequency band, periodic ULgaps located within this frequency band can be allocated for the user device to meet the user device's needs.

In some possible embodiments, the configuration assistance information includes the second assistance information configured for indicating the period of the interference on the uplink signal, and the fourth assistance information configured for indicating at least two frequency bands that are interfered. In this embodiment, when the user device reports the period of the interference on the uplink signal which is applicable to different frequency bands, periodic ULgaps located within these different frequency bands can be allocated for the user device to meet the user device's needs.

In some possible embodiments, the configuration assistance information includes the first assistance information configured for indicating the first time domain length during which the uplink signal is interfered, the second assistance information configured for indicating the period of the interference on the uplink signal, and the third assistance information configured for indicating a frequency band that is interfered. In this embodiment, when the user device reports the first time domain length and period of interference of the uplink signal applicable to the same frequency band, periodic ULgaps within this same frequency band can be allocated for the user device as a priority, or non-periodic ULgap(s) within this same frequency band can be allocated for the user device as a priority, providing different configuration options for the user.

In some possible embodiments, the configuration assistance information includes the first assistance information configured for indicating the first time domain length during which the uplink signal is interfered, the second assistance information configured for indicating the period of the interference on the uplink signal, and the fourth assistance information configured for indicating at least two frequency bands that are interfered. In this embodiment, when the user device reports the first time domain length and period of the interference of the uplink signal applicable to different frequency bands, periodic ULgaps located within these different frequency bands can be allocated for the user device as a priority, or non-periodic ULgap(s) located within these different frequency bands can be allocated for the user device as a priority, providing different configuration options for the user.

In some possible embodiments, the configuration assistance information includes the first assistance information configured for indicating the first time domain length during which the uplink signal is interfered, the second assistance information configured for indicating the period of the interference on the uplink signal, the third assistance information configured for indicating a frequency band that is interfered, and the fourth assistance information configured for indicating at least two frequency bands that are interfered. In this embodiment, when the user device reports the first time domain length and period of the interference of the uplink signal applicable to the same frequency band or different frequency bands, periodic ULgaps located within the same frequency band or different frequency bands can be allocated for the user device as a priority, providing different configuration options for the user.

According to the embodiments of this disclosure, a method for configuring an uplink gap is provided, which is performed by a user device. The method includes:
sending configuration assistance information to a network device, where the configuration assistance information is configured for the network device to determine the ULgap configuration information based on the configuration assistance information; and
receiving the ULgap configuration information from the network device, where the ULgap configuration information is configured for indicating a gap in which the user device is prohibited from scheduling uplink information when an uplink signal is interfered with by an IDC signal, and the ULgap configuration information includes a second time domain length, the second time domain length corresponding to a length (length of time, or duration) of the uplink gap.

In some possible embodiments, the method further includes: sending a configuration request to the network device, where the configuration request is configured for requesting the network device to configure the ULgap configuration information for the user device.

In some possible embodiments, the configuration assistance information includes at least one kind of the following information:
first assistance information configured for indicating a first time domain length during which the uplink signal is interfered;
second assistance information configured for indicating a period of the interference on the uplink signal;
third assistance information configured for indicating a frequency band that is interfered; or
fourth assistance information configured for indicating at least two frequency bands that are interfered.

In the embodiments of this disclosure, when the network device receives configuration assistance information from the user device, it configures a non-periodic ULgap for the user device.

In some possible examples, the ULgap configuration information includes a non-periodic ULgap, where the second time domain length is the length of this ULgap.

In some possible examples, the ULgap configuration information includes more than one non-periodic ULgap, where the second time domain length is the length of all of the more than one non-periodic ULgap.

In some possible examples, the ULgap configuration information includes more than one non-periodic ULgap and the second time domain length, where the ULgap configuration information includes the position and length of each non-periodic ULgap, and the second time domain length is the length of all of the more than one non-periodic ULgap.

In some possible examples, the ULgap configuration information includes more than one non-periodic ULgap and the second time domain length, where the ULgap configuration information does not include the position and length of each non-periodic ULgap. The UE can determine the position and length of the non-periodic ULgap based on the configuration information of uplink slots and downlink slots. For example, the non-periodic ULgaps are all of the uplink slots within the time period corresponding to the second time domain length.

In some possible embodiments, the configuration assistance information includes the first assistance information configured for indicating the first time domain length during which the uplink signal is interfered. In this embodiment, when the user device reports the first time domain length during which the uplink signal is interfered, corresponding non-periodic ULgap(s) is/are allocated for the user device to meet the user device's needs.

In some possible embodiments, the configuration assistance information includes the first assistance information configured for indicating the first time domain length during which the uplink signal is interfered, and the third assistance information configured for indicating a frequency band that is interfered. In this embodiment, when the user device reports the first time domain length during which the uplink signal is interfered, which is applicable to the same frequency band, non-periodic ULgap(s) located within this frequency band can be allocated for the user device to meet the user device's needs.

In some possible embodiments, the configuration assistance information includes the first assistance information configured for indicating the first time domain length during which the uplink signal is interfered, and the fourth assistance information configured for indicating at least two frequency bands that are interfered. In this embodiment, when the user device reports the first time domain length during which the uplink signal is interfered, which is applicable to different frequency bands, non-periodic ULgap(s) located within these different frequency bands can be allocated for the user device to meet the user device's needs.

In some possible embodiments, the configuration assistance information includes the first assistance information configured for indicating the first time domain length during which the uplink signal is interfered, the second assistance information configured for indicating the period of the interference on the uplink signal, and the third assistance information configured for indicating a frequency band that is interfered. In this embodiment, when the user device reports the first time domain length and period of interference of the uplink signal applicable to the same frequency band, non-periodic ULgap(s) located within this same frequency band can be allocated for the user device as a priority, or periodic ULgaps located within this same frequency band can be allocated for the user device as a priority, providing different configuration options for the user.

In some possible embodiments, the configuration assistance information includes the first assistance information configured for indicating the first time domain length during which the uplink signal is interfered, the second assistance information configured for indicating the period of the interference on the uplink signal, and the fourth assistance information configured for indicating at least two frequency bands that are interfered. In this embodiment, when the user device reports the first time domain length and period of interference of the uplink signal applicable to different frequency bands, non-periodic ULgap(s) located within these different frequency bands can be allocated for the user device as a priority, or periodic ULgaps located within these different frequency bands can be allocated for the user device as a priority, providing different configuration options for the user

In some possible embodiments, the configuration assistance information includes the first assistance information configured for indicating the first time domain length during which the uplink signal is interfered, the second assistance information configured for indicating the period of the interference on the uplink signal, the third assistance information configured for indicating a frequency band that is interfered, and the fourth assistance information configured for indicating at least two frequency bands that are interfered. In this embodiment, when the user device reports the first time domain length and period of interference of the uplink signal applicable to the same frequency band or different frequency bands, non-periodic ULgap(s) located within the same frequency band or different frequency bands can be allocated for the user device as a priority, providing different configuration options for the user.

According to the embodiments of this disclosure, a method for configuring an uplink gap is provided, which is performed by a user device. The method includes:
sending configuration assistance information to a network device, where the configuration assistance information is configured for the network device to determine ULgap configuration information based on the configuration assistance information; and
receiving the ULgap configuration information from the network device, where the ULgap configuration information is configured for indicating a gap in which the user device is prohibited from scheduling uplink information when an uplink signal is interfered with by an IDC signal, and the ULgap configuration information includes at least one of the following:
a repetition period of the uplink gaps, where a length of the period of the uplink gaps is a length of time or a multiple based on a unit time domain length;
a length of the uplink gaps; or
a starting offset value of the uplink gaps.

Furthermore, the ULgap configuration information includes an ULgap type, the ULgap type being a per-band type or a band combination-based type.

In some possible examples, the unit time domain length may be a configurable time domain length, such as a single-slot length, a half-slot length, a two-slot length, or a length greater than two slots.

In some possible implementations, the configuration assistance information includes at least one kind of the following information:
first assistance information configured for indicating a first time domain length during which the uplink signal is interfered;
second assistance information configured for indicating a period of the interference on the uplink signal;
third assistance information configured for indicating a frequency band that is interfered; or
fourth assistance information configured for indicating at least two frequency bands that are interfered.

In the embodiments of this disclosure, when the network device receives configuration assistance information from the user device, it configures the user device with periodic ULgaps located within the same frequency band or different frequency bands.

In some possible embodiments, the configuration assistance information includes the second assistance information configured for indicating the period of the interference on the uplink signal, and the third assistance information configured for indicating a frequency band that is interfered. In this embodiment, when the user device reports the period of the interference on the uplink signal which is applicable to the same frequency band, periodic ULgaps located within this frequency band can be allocated for the user device to meet the user device's needs.

In some possible embodiments, the configuration assistance information includes the second assistance information configured for indicating the period of the interference on the uplink signal, and the fourth assistance information configured for indicating at least two frequency bands that are interfered. In this embodiment, when the user device reports the period of the interference on the uplink signal which is applicable to different frequency bands, periodic ULgaps located within these different frequency bands can be allocated for the user device to meet the user device's needs.

In some possible embodiments, the configuration assistance information includes the first assistance information configured for indicating the first time domain length during which the uplink signal is interfered, the second assistance information configured for indicating the period of the interference on the uplink signal, and the third assistance information configured for indicating the frequency band that is interfered. In this embodiment, when the user device reports the first time domain length and period of interference of the uplink signal applicable to the same frequency band, periodic ULgaps located within this same frequency band can be allocated for the user device as a priority, or non-periodic ULgap(s) located within this same frequency band can be allocated for the user device as a priority, providing different configuration options for the user.

In some possible embodiments, the configuration assistance information includes the first assistance information configured for indicating the first time domain length during which the uplink signal is interfered, the second assistance information configured for indicating the period of the interference on the uplink signal, and the fourth assistance information configured for indicating at least two frequency bands that are interfered. In this embodiment, when the user device reports the first time domain length and period of the interference of the uplink signal applicable to different frequency bands, periodic ULgaps located within these different frequency bands can be allocated for the user device as a priority, or non-periodic ULgap(s) located within these different frequency bands can be allocated for the user device as a priority, providing different configuration options for the user.

In some possible embodiments, the configuration assistance information includes the first assistance information configured for indicating the first time domain length during which the uplink signal is interfered, the second assistance information configured for indicating the period of the interference on the uplink signal, the third assistance information configured for indicating a frequency band that is interfered, and the fourth assistance information configured for indicating at least two frequency bands that are interfered. In this embodiment, when the user device reports the first time domain length and period of the interference of the uplink signal applicable to the same frequency band or different frequency bands, periodic ULgaps located within the same frequency band or different frequency bands can be allocated for the user device as a priority, providing different configuration options for the user.

According to the embodiments of this disclosure, a method for configuring an uplink gap is provided, which is performed by a user device. The method includes:
sending configuration assistance information to a network device, where the configuration assistance information is configured for the network device to determine the ULgap configuration information based on the configuration assistance information; and
receiving the ULgap configuration information from the network device, where the ULgap configuration information is configured for indicating a gap in which the user device is prohibited from scheduling uplink information when an uplink signal is interfered with by an IDC signal, and the ULgap configuration information includes a second time domain length, the second time domain length corresponding to a length (length of time, or duration) of the uplink gap.

In some possible embodiments, the method further includes: sending a configuration request to the network device, where the configuration request is configured for requesting the network device to configure the ULgap configuration information for the user device.

In some possible embodiments, the configuration assistance information includes at least one kind of the following information:
first assistance information configured for indicating a first time domain length during which the uplink signal is interfered;
second assistance information configured for indicating a period of the interference on the uplink signal;
third assistance information configured for indicating a frequency band that is interfered; or
fourth assistance information configured for indicating at least two frequency bands that are interfered.

In the embodiments of this disclosure, when the network device receives configuration assistance information from the user device, it configures a non-periodic ULgap for the user device.

In some possible embodiments, the configuration assistance information includes the first assistance information configured for indicating the first time domain length during which the uplink signal is interfered, and the third assistance information configured for indicating a frequency band that is interfered. In this embodiment, when the user device reports the first time domain length during which the uplink signal is interfered, which is applicable to the same frequency band, non-periodic ULgap(s) located within this frequency band can be allocated for the user device to meet the user device's needs.

In some possible embodiments, the configuration assistance information includes the first assistance information configured for indicating the first time domain length during which the uplink signal is interfered, and the fourth assistance information configured for indicating at least two frequency bands that are interfered. In this embodiment, when the user device reports the first time domain length during which the uplink signal is interfered, which is applicable to different frequency bands, non-periodic ULgap(s) located within these different frequency bands can be allocated for the user device to meet the user device's needs.

In some possible embodiments, the configuration assistance information includes the first assistance information configured for indicating the first time domain length during which the uplink signal is interfered, the second assistance information configured for indicating the period of the interference on the uplink signal, and the third assistance information configured for indicating a frequency band that is interfered. In this embodiment, when the user device reports the first time domain length and period of interference of the uplink signal applicable to the same frequency band, non-periodic ULgap(s) located within this same frequency band can be allocated for the user device as a priority, or periodic ULgaps located within this same frequency band can be allocated for the user device as a priority, providing different configuration options for the user.

In some possible embodiments, the configuration assistance information includes the first assistance information configured for indicating the first time domain length during which the uplink signal is interfered, the second assistance information configured for indicating the period of the interference on the uplink signal, and the fourth assistance information configured for indicating at least two frequency bands that are interfered. In this embodiment, when the user device reports the first time domain length and period of interference of the uplink signal applicable to different frequency bands, non-periodic ULgap(s) located within these different frequency bands can be allocated for the user device as a priority, or periodic ULgaps located within these different frequency bands can be allocated for the user device as a priority, providing different configuration options for the user.

In some possible embodiments, the configuration assistance information includes the first assistance information configured for indicating the first time domain length during which the uplink signal is interfered, the second assistance information configured for indicating the period of the interference on the uplink signal, the third assistance information configured for indicating a frequency band that is interfered, and the fourth assistance information configured for indicating at least two frequency bands that are interfered. In this embodiment, when the user device reports the first time domain length and period of interference of the uplink signal applicable to the same frequency band or different frequency bands, non-periodic ULgap(s) located within the same frequency band or different frequency bands can be allocated for the user device as a priority, providing different configuration options for the user.

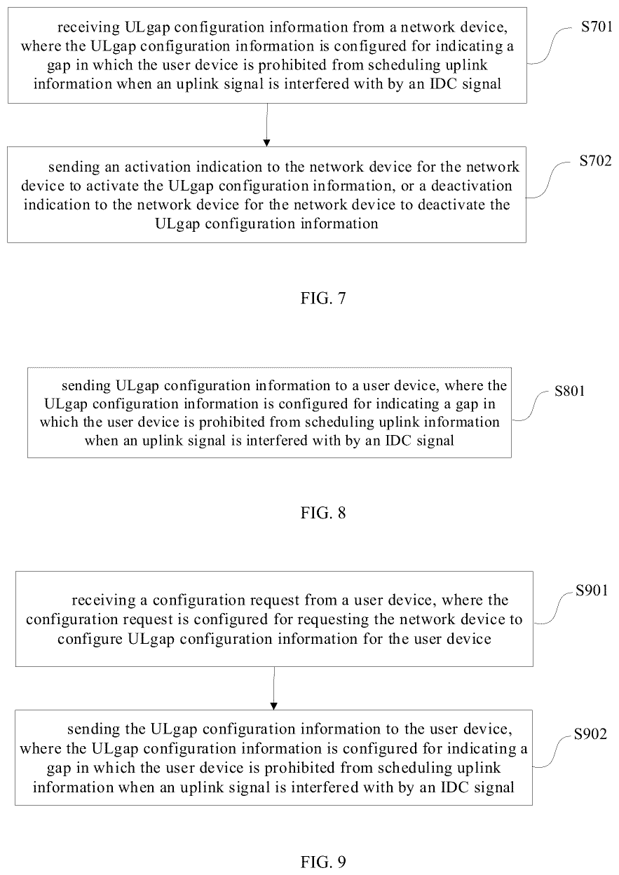

According to the embodiments of this disclosure, a method for configuring an uplink gap is provided, which is performed by a user device. FIG. 7 is a flowchart of a method for configuring an uplink gap illustrated according to an embodiment. As shown in FIG. 7, the method includes the following steps.

Step S701, receiving ULgap configuration information from a network device, where the ULgap configuration information is configured for indicating a gap in which the user device is prohibited from scheduling uplink information when an uplink signal is interfered with by an IDC signal.

Step S702, sending an activation indication to the network device for the network device to activate the ULgap configuration information, or a deactivation indication to the network device for the network device to deactivate the ULgap configuration information.

In some possible embodiments, sending the activation indication to the network device for the network device to activate the ULgap configuration information or the deactivation indication to the network device for the network device to deactivate the ULgap configuration information, includes:
sending dynamic signaling to the network device, where the dynamic signaling includes the activation indication configured for the network device to activate the ULgap configuration information or the deactivation indication configured for the network device to deactivate the ULgap configuration information,
where the dynamic signaling is Radio Resource Control (RRC) signaling, Medium Access Control (MAC) signaling, or Uplink Control Information (UCI) signaling.

According to the embodiments of this disclosure, a method for configuring an uplink gap is provided, which is performed by a network device. FIG. 8 is a flowchart of a method for configuring an uplink gap illustrated according to an embodiment. As shown in FIG. 8, the method includes the following steps.

Step S801, sending ULgap configuration information to a user device, where the ULgap configuration information is configured for indicating a gap in which the user device is prohibited from scheduling uplink information when an uplink signal is interfered with by an IDC signal.

In some possible embodiments, the IDC signal may be at least one kind of the following signals: a WLAN signal, a Bluetooth signal, a GNSS signal, or an USB signal.

In some possible embodiments, after receiving the ULgap configuration information sent by the network device, the user device does not schedule uplink information within the gap(s) indicated by the ULgap configuration information.

In the embodiments of this disclosure, the network device configures the ULgap configuration information for the user device, where the ULgap configuration information corresponds to one or more ULgaps which correspond to a period during which an uplink signal is interfered with by an IDC signal, so as to prohibit scheduling of uplink information by the user device within the corresponding gap(s). This prevents the user device from sending interfered-uplink information to the network device and affecting the effectiveness of the uplink information, thereby improving the communication quality, and optimizing the network performance.

According to the embodiments of this disclosure, a method for configuring an uplink gap is provided, which is performed by a network device. FIG. 9 is a flowchart of a method for configuring an uplink gap illustrated according to an embodiment. As shown in FIG. 9, the method includes the following steps.

Step S901, receiving a configuration request from a user device, where the configuration request is configured for requesting the network device to configure ULgap configuration information for the user device.

Step S902, sending the ULgap configuration information to the user device, where the ULgap configuration information is configured for indicating a gap in which the user device is prohibited from scheduling uplink information when an uplink signal is interfered with by an IDC signal.

In some possible embodiments, the IDC signal may be at least one kind of the following signals: a WLAN signal, a Bluetooth signal, a GNSS signal, or an USB signal.

In some possible embodiments, the ULgap configuration information is default ULgap configuration information.

In some possible embodiments, the ULgap configuration information is preset ULgap configuration information.

In some possible embodiments, the ULgap configuration information is configured for configuring periodic ULgaps.

The ULgap configuration information includes at least one kind of the following:
a repetition period of the uplink gaps, where a length of the period of the uplink gaps is a length of time or a multiple based on a unit time domain length;
a length of the uplink gaps; or
a starting offset value of the uplink gaps.

In some possible examples, the unit time domain length may be a configurable time domain length, such as a single-slot length, a half-slot length, a two-slot length, or a length greater than two slots.

In some possible embodiments, the ULgap configuration information is configured for configuring non-periodic ULgap(s).

The ULgap configuration information includes a second time domain length, where the second time domain length corresponds to a length (a length of time, or duration) of the uplink gap.

In some possible embodiments, the ULgap configuration information is configured for configuring the periodic ULgaps or non-periodic ULgap, and the ULgap configuration information also includes an ULgap type, where the ULgap type is a per-band type or a band combination-based type.

In the embodiments of this disclosure, after receiving a configuration request actively sent by the user device to the network device, the network device sends the ULgap configuration information to the user device, allowing the network device to send ULgap configuration information only when needed by the user device, thus saving transmission resources.

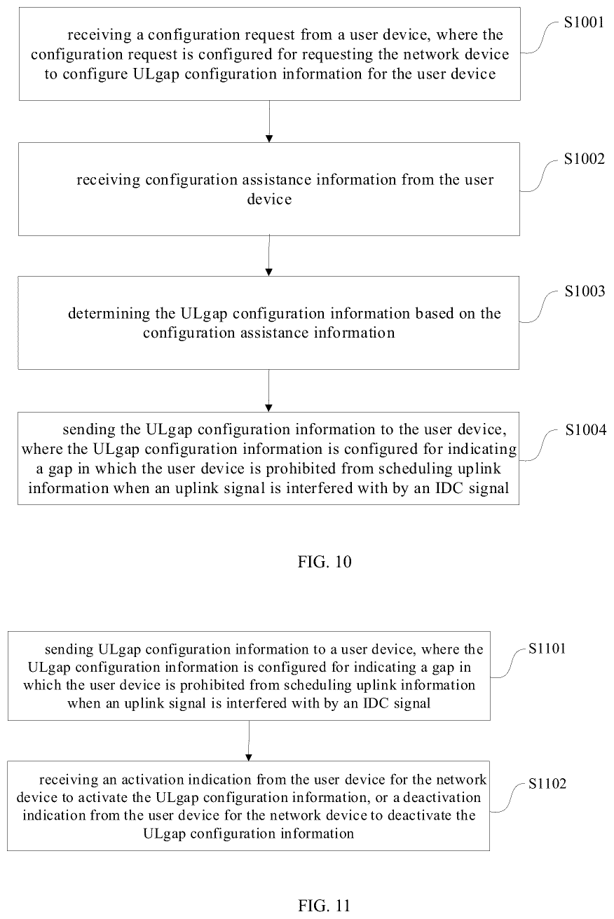

According to the embodiments of this disclosure, a method for configuring an uplink gap is provided, which is performed by a network device. FIG. 10 is a flowchart of a method for configuring an uplink gap illustrated according to an embodiment. As shown in FIG. 10, the method includes the following steps.

Step S1001, receiving a configuration request from a user device, where the configuration request is configured for requesting the network device to configure ULgap configuration information for the user device.

Step S1002, receiving configuration assistance information from the user device.

Step S1003, determining the ULgap configuration information based on the configuration assistance information.

Step S1004, sending the ULgap configuration information to the user device, where the ULgap configuration information is configured for indicating a gap in which the user device is prohibited from scheduling uplink information when an uplink signal is interfered with by an IDC signal.

Alternatively, the method does not include step S1001 but only includes steps S1002, S1003, and S1004.

In some possible embodiments, the IDC signal may be at least one kind of the following signals: a WLAN signal, a Bluetooth signal, a GNSS signal, or an USB signal.

In some possible embodiments, the configuration assistance information includes at least one kind of the following information:
first assistance information configured for indicating a first time domain length during which the uplink signal is interfered;
second assistance information configured for indicating a period of the interference on the uplink signal;
third assistance information configured for indicating a frequency band that is interfered; or
fourth assistance information configured for indicating at least two frequency bands that are interfered.

In some possible embodiments, the first time domain length is a total number of time slots or a total length of time when the uplink signal is interfered by the IDC signal.

In the embodiments of this disclosure, the network device receives configuration assistance information actively sent by the user device, and determines ULgap configuration information based on the configuration assistance information. In this way, the network device determines the ULgap configuration information based on the configuration assistance information reported by the user device, which enables the network device to configure the ULgap configuration information required by the user device based on the needs of the user device, thereby optimizing the network performance.

According to the embodiments of this disclosure, a method for configuring an uplink gap is provided, which is performed by a network device. The method includes:
receiving configuration assistance information from a user device, where the configuration assistance information is configured for the network device to determine ULgap configuration information based on the configuration assistance information; and
sending the ULgap configuration information to the user device, where the ULgap configuration information is configured for indicating a gap in which the user device is prohibited from scheduling uplink information when an uplink signal is interfered with by an IDC signal, and the ULgap configuration information includes at least one kind of the following:
a repetition period of the uplink gaps, where a length of the period of the uplink gaps is a length of time or a multiple based on a unit time domain length;
a length of the uplink gaps; or
a starting offset value of the uplink gaps.

In some possible examples, the unit time domain length may be a single-slot length, a half-slot length, or a two-slot length.

In some possible embodiments, the configuration assistance information includes at least one kind of the following information:
first assistance information configured for indicating a first time domain length during which the uplink signal is interfered;
second assistance information configured for indicating a period of the interference on the uplink signal;
third assistance information configured for indicating a frequency band that is interfered; or
fourth assistance information configured for indicating at least two frequency bands that are interfered.

In the embodiments of this disclosure, when the network device receives configuration assistance information from the user device, it configures periodic ULgaps for the user device.

According to the embodiments of this disclosure, a method for configuring an uplink gap is provided, which is performed by a network device. The method includes:
receiving configuration assistance information from a user device, where the configuration assistance information is configured for the network device to determine ULgap configuration information based on the configuration assistance information; and
sending the ULgap configuration information to the user device, where the ULgap configuration information is configured for indicating a gap in which the user device is prohibited from scheduling uplink information when an uplink signal is interfered with by an IDC signal, and the ULgap configuration information includes a second time domain length, the second time domain length corresponding to a length (length of time, or duration) of the uplink gap.

In some possible embodiments, the method further includes: receiving a configuration request from the user device, where the configuration request is configured for requesting the network device to configure the ULgap configuration information for the user device.

In some possible embodiments, the configuration assistance information includes at least one kind of the following information:
first assistance information configured for indicating a first time domain length during which the uplink signal is interfered;
second assistance information configured for indicating a period of the interference on the uplink signal;
third assistance information configured for indicating a frequency band that is interfered; or
fourth assistance information configured for indicating at least two frequency bands that are interfered.

In the embodiments of this disclosure, when the network device receives configuration assistance information from the user device, it configures a non-periodic ULgap for the user device.

According to the embodiments of this disclosure, a method for configuring an uplink gap is provided, which is performed by a network device. The method includes:
receiving configuration assistance information from a user device, where the configuration assistance information is configured for the network device to determine ULgap configuration information based on the configuration assistance information; and
sending the ULgap configuration information to the user device, where the ULgap configuration information is configured for indicating a gap in which the user device is prohibited from scheduling uplink information when an uplink signal is interfered with by an IDC signal, and the ULgap configuration information includes at least one kind of the following:
a repetition period of the uplink gaps, where a length of the period of the uplink gaps is a length of time or a multiple based on a unit time domain length;
a length of the uplink gaps; or
a starting offset value of the uplink gaps.

Furthermore, the ULgap configuration information includes an ULgap type, the ULgap type being a per-band type or a band combination-based type.

In some possible examples, the unit time domain length may be a configurable time domain length. For example, the unit time domain length is a single-slot length, a half-slot length, a two-slot length, or a length greater than two slots.

In some possible implementations, the configuration assistance information includes at least one kind of the following information:
first assistance information configured for indicating a first time domain length during which the uplink signal is interfered;
second assistance information configured for indicating a period of the interference on the uplink signal;
third assistance information configured for indicating a frequency band that is interfered; or
fourth assistance information configured for indicating at least two frequency bands that are interfered.

In the embodiments of this disclosure, when the network device receives configuration assistance information from the user device, it configures the user device with periodic ULgaps located within the same frequency band or different frequency bands.

According to the embodiments of this disclosure, a method for configuring an uplink gap is provided, which is performed by a network device. The method includes:
receiving configuration assistance information from a user device, where the configuration assistance information is configured for the network device to determine ULgap configuration information based on the configuration assistance information; and
sending the ULgap configuration information to the user device, where the ULgap configuration information is configured for indicating a gap in which the user device is prohibited from scheduling uplink information when an uplink signal is interfered with by an IDC signal, and the ULgap configuration information includes a second time domain length, the second time domain length corresponding to a length (length of time, or duration) of the uplink gap.

In some possible embodiments, the method further includes: receiving a configuration request from the user device, where the configuration request is configured for requesting the network device to configure the ULgap configuration information for the user device.

In some possible embodiments, the configuration assistance information includes at least one kind of the following information:
first assistance information configured for indicating a first time domain length during which the uplink signal is interfered;
second assistance information configured for indicating a period of the interference on the uplink signal;
third assistance information configured for indicating a frequency band that is interfered; or
fourth assistance information configured for indicating at least two frequency bands that are interfered.

In the embodiments of this disclosure, when the network device receives configuration assistance information from the user device, it configures a non-periodic ULgap for the user device.

According to the embodiments of this disclosure, a method for configuring an uplink gap is provided, which is performed by a network device. FIG. 11 is a flowchart of a method for configuring an uplink gap illustrated according to an embodiment. As shown in FIG. 11, the method includes the following steps.

Step S1101, sending ULgap configuration information to a user device, where the ULgap configuration information is configured for indicating a gap in which the user device is prohibited from scheduling uplink information when an uplink signal is interfered with by an IDC signal.

Step S1102, receiving an activation indication from the user device for the network device to activate the ULgap configuration information, or a deactivation indication from the user device for the network device to deactivate the ULgap configuration information.

In some possible embodiments, receiving the activation indication from the user device for the network device to activate the ULgap configuration information or the deactivation indication from the user device for the network device to deactivate the ULgap configuration information, includes:
receiving dynamic signaling from the user device, where the dynamic signaling includes the activation indication configured for the network device to activate the ULgap configuration information or the deactivation indication configured for the network device to deactivate the ULgap configuration information,
where the dynamic signaling is RRC signaling, MAC signaling, or UCI signaling.

Based on the same concept as the above method embodiments, this disclosure also provides a communication device that can perform the functions of the user device 102 in the method embodiments described above, and is used to execute the steps performed by the user device 102 provided by the embodiments. These functions can be implemented through hardware, software, or hardware executing the corresponding software. The hardware or software includes one or more modules corresponding to these functions.

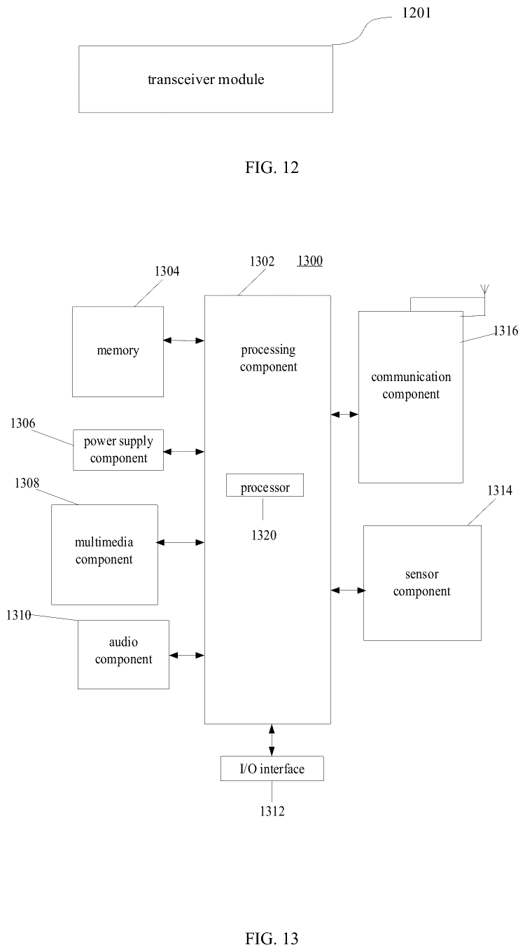

In one possible embodiment, the communication device 1200 shown in FIG. 12 can serve as the user device 102 involved in the method embodiments described above and execute the steps performed by the user device 102 in one of the method embodiments.

The communication device 1200 includes a transceiver module 1201 configured to receive uplink gap (ULgap) configuration information from a network device, where the ULgap configuration information is configured for indicating a gap in which the user device is prohibited from scheduling uplink information when an uplink signal is interfered with by an IDC signal.

In one possible embodiment, the transceiver module 1201 is further configured to send a configuration request to the network device, where the configuration request is configured for requesting the network device to configure the ULgap configuration information for the user device.

In one possible embodiment, the transceiver module 1201 is further configured to send configuration assistance information to the network device, where the configuration assistance information is configured for the network device to determine the ULgap configuration information based on the configuration assistance information.

In one possible embodiment, the configuration assistance information includes at least one of:
first assistance information configured for indicating a first time domain length during which the uplink signal is interfered;
second assistance information configured for indicating a period of the interference on the uplink signal;
third assistance information configured for indicating a frequency band that is interfered; or
fourth assistance information configured for indicating at least two frequency bands that are interfered.

In one possible embodiment, the first time domain length is a number of time slots or a length of time during which the uplink signal is interfered with by the IDC signal.

In one possible embodiment, the ULgap configuration information includes at least one of:
a repetition period of the uplink gaps, where a length of the period of the uplink gaps is a length of time or a multiple based on a unit time domain length;
a length of the uplink gaps; or
a starting offset value of the uplink gaps.

In one possible embodiment, the ULgap configuration information includes a second time domain length, which corresponds to a length of time of the uplink gap.

In one possible embodiment, the ULgap configuration information includes an ULgap type, the ULgap type being a per-band type or a band combination-based type.

In one possible embodiment, the transceiver module 1101 is further configured to send an activation indication to the network device for the network device to activate the ULgap configuration information, or a deactivation indication to the network device for the network device to deactivate the ULgap configuration information.

In one possible embodiment, the transceiver module 1101 is further configured to: send dynamic signaling to the network device, where the dynamic signaling includes the activation indication configured for the network device to activate the ULgap configuration information or the deactivation indication configured for the network device to deactivate the ULgap configuration information;
where the dynamic signaling is RRC signaling, MAC signaling, or UCI signaling.

When the communication device serves as the user device, its structure can be as shown in FIG. 13.

FIG. 13 is a block diagram of a device 1300 for configuring an uplink gap according to an implementation. For example, the device 1300 can be a mobile phone, computer, digital broadcast terminal, message transceiver device, game console, tablet device, medical device, fitness equipment, personal digital assistant, etc.

Referring to FIG. 13, the device 1300 may include one or more of the following components: a processing component 1302, a memory 1304, a power supply component 1306, a multimedia component 1308, an audio component 1310, an input/output (I/O) interface 1312, a sensor component 1314, and a communication component 1316.

The processing component 1302 typically controls the overall operation of device 1300, such as operations related to display, phone calls, data communication, camera operations, and recording operations. The processing component 1302 may include one or more processors 1320 to execute instructions to complete some or all steps of the above methods. Additionally, the processing component 1302 may include one or more modules to facilitate interaction between the processing component 1302 and other components. For example, the processing component 1302 may include a multimedia module to facilitate interaction between the multimedia component 1308 and the processing component 1302.

The memory 1304 is configured to store various types of data to support the operations on the device 1300. Examples of this data include instructions for any applications or methods operating on the device 1300, contact data, phonebook data, messages, images, videos, etc. The memory 1304 can be implemented by any type of volatile or non-volatile storage device or a combination thereof, such as static random-access memory (SRAM), electrically erasable programmable read-only memory (EEPROM), erasable programmable read-only memory (EPROM), programmable read-only memory (PROM), read-only memory (ROM), magnetic storage, flash memory, disk, or optical disc.

The power supply component 1306 provides power to various components of the device 1300. The power supply component 1306 may include a power management system, one or more power sources, and other components associated with generating, managing, and distributing power for the device 1300.

The multimedia component 1308 includes a screen that provides an output interface between the device 1300 and the user. In some embodiments, the screen may include a liquid crystal display (LCD) and a touch panel (TP). If the screen includes a touch panel, it can be implemented as a touch screen to receive input signals from the user. The touch panel includes one or more touch sensors to detect touch, swipe, and gestures on the touch panel. The touch sensor may not only detect the boundaries of touch or swipe actions but also detect the duration and pressure associated with the touch or swipe operation. In some embodiments, the multimedia component 1308 includes a front camera and/or rear camera. When the device 1300 is in operation mode, such as shooting mode or video mode, the front camera and/or rear camera can receive external multimedia data. Each front and rear camera can be a fixed optical lens system or have focal length and optical zoom capabilities.

The audio component 1310 is configured to output and/or input audio signals. For example, the audio component 1310 includes a microphone (MIC), which is configured to receive external audio signals when the device 1300 is in operation mode, such as call mode, recording mode, and voice recognition mode. The received audio signals can be further stored in the memory 1304 or sent via the communication component 1316. In some embodiment, the audio component 1310 also includes a speaker for outputting audio signals.

The I/O interface 1312 provides an interface between the processing component 1302 and peripheral interface modules, which can be a keyboard, trackball, buttons, etc. These buttons may include but are not limited to: home button, volume buttons, power button, and lock button.

The sensor component 1314 includes one or more sensors for providing status evaluations of various aspects of the device 1300. For example, the sensor component 1314 can detect the open/close status of the device 1300, relative positioning of components such as the display and keypad of the device 1300, changes in the position of the device 1300 or a component of the device 1300, presence or absence of user contact with the device 1300, orientation or acceleration/deceleration of the device 1300, and temperature changes of the device 1300. The sensor component 1314 may include a proximity sensor configured to detect the presence of nearby objects without any physical contact. The sensor component 1314 may also include light sensors, such as CMOS or CCD image sensors, for imaging applications. In some embodiments, the sensor component 1314 may also include accelerometers, gyroscopes, magnetic sensors, pressure sensors, or temperature sensors.

The communication component 1316 is configured to facilitate wired or wireless communication between the device 1300 and other devices. The device 1300 can access wireless networks based on communication standards such as Wi-Fi, 4G, or 5G, or their combinations. In an embodiment, the communication component 1316 receives broadcast signals or broadcast-related information from an external broadcast management system via a broadcast channel. In an embodiment, the communication component 1316 also includes a Near Field Communication (NFC) module for facilitating short-range communication. For example, the NFC module can be based on radio frequency identification (RFID) technology, Infrared Data Association (IrDA) technology, Ultra-Wideband (UWB) technology, Bluetooth (BT) technology, and other technologies.

In embodiments, the device 1300 can be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components to execute the above methods.

Based on the same concept as the above method embodiments, this disclosure also provides a communication device that can perform the functions of the network device 101 in the method embodiments described above, and is used to execute the steps performed by the network device 101 provided in the embodiments described above. These functions can be implemented through hardware, software, or hardware executing the corresponding software. The hardware or software includes one or more modules corresponding to these functions.

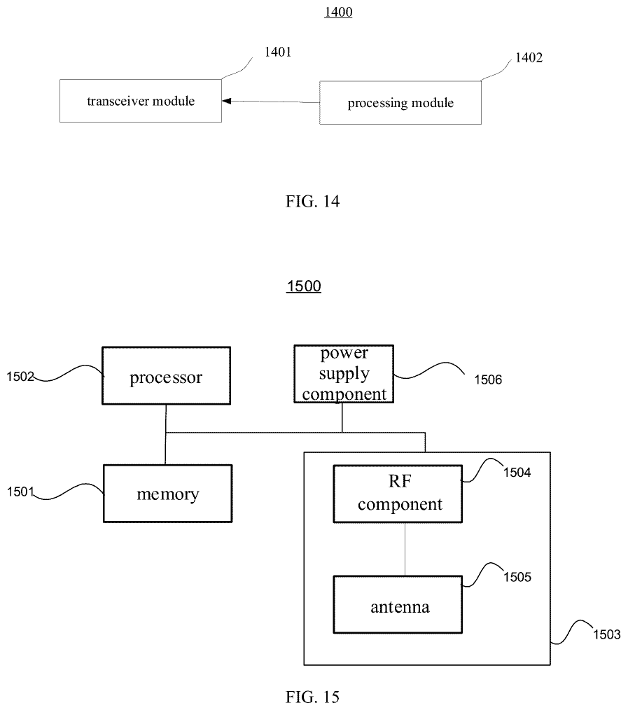

In a possible embodiment, a communication device 1400 shown in FIG. 14 can serve as the network device 101 involved in the method embodiments described above and execute the steps performed by the network device 101 in one of the method embodiments described above.

The communication device 1400 includes: a transceiver module 1401 and a processing module 1402.

The transceiver module 1401 is configured to send uplink gap (ULgap) configuration information to a user device, where the ULgap configuration information is configured for indicating a gap in which the user device is prohibited from scheduling uplink information when an uplink signal is interfered with by an IDC signal.

In a possible embodiment, the transceiver module 1401 is further configured to receive a configuration request from the user device, where the configuration request is configured for requesting the network device to configure the ULgap configuration information for the user device.

In a possible embodiment, the transceiver module 1401 is further configured to receive configuration assistance information from the user device; and
the processing module 1402 is configured to determine the ULgap configuration information based on the configuration assistance information.

In a possible embodiment, the configuration assistance information includes at least one of:
first assistance information configured for indicating a first time domain length during which the uplink signal is interfered;
second assistance information configured for indicating a period of the interference on the uplink signal;
third assistance information configured for indicating a frequency band that is interfered; or
fourth assistance information configured for indicating at least two frequency bands that are interfered.

In a possible embodiment, the time domain length is a number of time slots or a length of time during which the uplink signal is interfered with by the IDC signal.

In a possible embodiment, the ULgap configuration information includes at least one of:
a repetition period of the uplink gaps, where a length of the period of the uplink gaps is a length of time or a multiple based on a unit time domain length;
a length of the uplink gaps; or
a starting offset value of the uplink gaps.

In a possible embodiment, the ULgap configuration information includes a second time domain length corresponding to a length of time of the uplink gap.

In a possible embodiment, the ULgap configuration information includes an ULgap type, the ULgap type being a per-band type or a band combination-based type.

In a possible embodiment, the transceiver module is further configured to receive an activation indication from the user device for the network device to activate the ULgap configuration information, or a deactivation indication from the user device for the network device to deactivate the ULgap configuration information.

In a possible embodiment, the transceiver module is further configured to receive dynamic signaling from the user device, where the dynamic signaling includes the activation indication configured for the network device to activate the ULgap configuration information or the deactivation indication configured for the network device to deactivate the ULgap configuration information,
where the dynamic signaling is RRC signaling, MAC signaling, or UCI signaling.

When the communication device serves as the network device, its structure can be as shown in FIG. 15. Taking the network device 101 as a base station for illustration of the structure of the communication device. As shown in FIG. 15, the device 1500 includes a memory 1501, a processor 1502, a transceiver component 1503, and a power supply component 1506. The memory 1501 is coupled to the processor 1502 and can be used to store programs and data necessary for implementing the functions of the communication device 1500. The processor 1502 is configured to support the execution of the corresponding functions in the communication device 1500 as described in the above methods, which can be achieved by calling the programs stored in the memory 1501. The transceiver component 1503 can be a wireless transceiver used to support the reception and/or transmission of signals and/or data through a wireless air interface. The transceiver component 1503 can also be referred to as a transceiver unit or communication unit, and may include an RF component 1504 and one or more antennas 1505, where the RF component 1504 can be a remote radio unit (RRU) specifically for transmitting RF signals and conversion between RF signals and baseband signals; and the one or more antennas 1505 can be specifically used for radiating and receiving RF signals.

When the communication device 1500 needs to send data, the processor 1502 can output a baseband signal to a radio frequency unit after baseband processing of the data to be sent, and the RF unit processes the baseband signal to RF signal and transmits the RF signal as electromagnetic waves through the antenna. When data is sent to the communication device 1500, the RF unit receives the RF signal through the antenna, converts the RF signal to baseband signal, and outputs the baseband signal to the processor 1502, where the processor 1502 converts the baseband signal to data and processes the data.

Those skilled in the art will readily appreciate other embodiments of the present disclosure after considering the specification and practicing the invention disclosed herein. The scope of the present disclosure is intended to cover any variations, uses, or adaptations of the embodiments of the present disclosure following the general principles thereof and including common knowledge or conventional techniques in the technical field not disclosed herein. The specification and examples are to be regarded as illustrative and the true scope and spirit of the present disclosure are indicated by the claims below.

It should be understood that the embodiments of the present disclosure are not limited to the precise structures described and illustrated in the figures, and various modifications and changes can be made without departing from the scope thereof. The scope of the present disclosure is defined only by the appended claims.

### INDUSTRIAL APPLICABILITY

The network device configures ULgap configuration information for the user device, where the ULgap configuration information corresponds to one or more ULgaps which correspond to a period during which an uplink signal is interfered with by an IDC signal, so as to prohibit scheduling of uplink information by the user device within the corresponding gap(s). This prevents the user device from sending interfered-uplink information to the network device and affecting the effectiveness of the uplink information, thereby improving the communication quality, and optimizing the network performance.

1. A method for configuring an uplink gap, performed by a user device, the method comprising:
receiving uplink gap (ULgap) configuration information from a network device, wherein the ULgap configuration information indicates a gap in which the user device is prohibited from scheduling uplink information when an uplink signal is interfered with by an In Device Coexistence (IDC) signal.

2. The method of claim 1, further comprising:
sending a configuration request to the network device, wherein the configuration request requests the network device to configure the ULgap configuration information for the user device.

3. The method of claim 1, further comprising:
sending configuration assistance information to the network device, wherein the configuration assistance information is configured for the network device to determine the ULgap configuration information based on the configuration assistance information.

4. The method of claim 3, wherein the configuration assistance information comprises at least one of following information:
first assistance information indicating a first time domain length during which the uplink signal is interfered;
second assistance information indicating a period of the interference on the uplink signal;
third assistance information indicating a frequency band that is interfered; or
fourth assistance information indicating at least two frequency bands that are interfered.

5. (canceled)

6. The method of claim 1, wherein the ULgap configuration information corresponds to periodic uplink gaps and comprises at least one of following information:
a repetition period of the uplink gaps, wherein a length of the repetition period of the uplink gaps is a length of time or a multiple based on a unit time domain length;
a length of the uplink gap; or
a starting offset value of the uplink gaps.

7. The method of claim 1, wherein the ULgap configuration information corresponds to a non-periodic uplink gap and comprises a second time domain length corresponding to a length of the uplink gap.

8. The method of claim 6, wherein the ULgap configuration information comprises an ULgap type, the ULgap type being a per-band type or a band combination-based type.

9. The method of claim 1, further comprising:
sending an activation indication to the network device for the network device to activate the ULgap configuration information, or a deactivation indication to the network device for the network device to deactivate the ULgap configuration information.

10. (canceled)

11. A method for configuring an uplink gap, performed by a network device, the method comprising:
sending uplink gap (ULgap) configuration information to a user device, wherein the ULgap configuration information indicates a gap in which the user device is prohibited from scheduling uplink information when an uplink signal is interfered with by an In Device Coexistence (IDC) signal.

12. The method of claim 11, further comprising:
receiving a configuration request from the user device, wherein the configuration request requests the network device to configure the ULgap configuration information for the user device.

13. The method of claim 11, further comprising:
receiving configuration assistance information from the user device; and
determining the ULgap configuration information based on the configuration assistance information.

14. The method of claim 13, wherein the configuration assistance information comprises at least one of following information:
first assistance information indicating a first time domain length during which the uplink signal is interfered;
second assistance information indicating a period of the interference on the uplink signal;
third assistance information indicating a frequency band that is interfered; or
fourth assistance information indicating at least two frequency bands that are interfered.

15. (canceled)

16. The method of claim 11, wherein the ULgap configuration information corresponds to periodic uplink gaps and comprises at least one of following information:
a repetition period of the uplink gaps, wherein a length of the repetition period of the uplink gaps is a length of time or a multiple based on a unit time domain length;
a length of the uplink gaps; or
a starting offset value of the uplink gaps.

17. The method of claim 11, wherein the ULgap configuration information corresponds to a non-periodic uplink gap and comprises a second time domain length corresponding to a length of the uplink gap.

18. The method of claim 16, wherein the ULgap configuration information comprises an ULgap type, the ULgap type being a per-band type or a band combination-based type.

19. The method of claim 11, further comprising:
receiving an activation indication from the user device for the network device to activate the ULgap configuration information, or a deactivation indication from the user device for the network device to deactivate the ULgap configuration information.

20-40. (canceled)

41. A communication device, comprising:
a memory configured to store a computer program; and
a processor configured to execute the computer program to perform acts comprising: receiving uplink gap (ULgap) configuration information from a network device, wherein the ULgap configuration information indicates a gap in which the communication device is prohibited from scheduling uplink information when an uplink signal is interfered with by an In Device Coexistence (IDC) signal.

42. A communication device, comprising:
a memory configured to store a computer program; and
a processor configured to execute the computer program to perform the method of claim 11.

43. A non-transitory computer-readable storage medium storing instructions which, when invoked and executed on a computer, cause the computer to perform the method of claim 1.

44. A non-transitory computer-readable storage medium storing instructions which, when invoked and executed on a computer, cause the computer to perform the method of claim 11.
